(19) United States
(12) Patent Application Publication
(10) Pub. No.: US 2004/0021906 A1
(43) Pub. Date: Feb. 5, 2004

(54) Peripheral device output job routing

(76) Inventor: Dennis W. Howard, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/213,024

(22) Filed: Aug. 5, 2002

(51) Int. Cl. G06F 15/00; B41F 1/00; B41J 1/00; G06K 1/00; B41B 1/00

(52) U.S. Cl. 358/1.16

(57) ABSTRACT

An address and a file naming convention are obtained for storing data in files that are to be output with a peripheral device. A file named according to the file naming convention is written to the address having data therein that is to be output by the peripheral device. If data is detected at address by monitoring thereof, the data in the corresponding file having a file name in accordance with file naming convention is sent to the address of the peripheral device to be output there from.

### FIELD OF THE INVENTION

The present invention relates to outputting an output job at an output device such as a peripheral device. More particularly, the invention relates to routing an output job to a peripheral device.

### BACKGROUND OF THE INVENTION

In many situations, an output device such as a peripheral device or a printer is coupled to a document processing device, such as a personal computer or a workstation, that helps render an output job (such as a print job) that is output by the peripheral device (e.g. printed by the printing device). The document processing device generates one or more output jobs to be output by the peripheral device. The document processing device can execute different kinds of applications each of which can generate an output job that can be output by the peripheral device upon a demand for same by a user. Prior to initiation of the demand for output, the user can input data, edit the data, delete the data, etc. For example, the output jobs can be generated by one or more application programs (e.g. word processing programs, electronic mail programs, drawing programs, spreadsheet programs, desk top publishing programs, etc.) executed by the document processing device.

The output jobs may include any type of graphical elements or information supported by the peripheral device, including text, pictures, and so forth. The document processing device typically translates the output job into a language that is understood by the peripheral device. Where the peripheral device is a printer, the language can be Printer Control Language (PCL) or Postscript. A particular peripheral device may understand a single language, thereby requiring the processing device to translate the output job into that single language. This type of peripheral device requires an attached processing device to convert the raw output job data into a format (i.e., language) that is understood by the peripheral device.

Some peripheral devices are capable of processing output jobs in multiple languages. These peripheral devices are typically more complicated because they are required to identify, interpret and process output commands in several different languages. Although these peripheral devices are more complicated, they typically require an attached processing device to provide the output job and other output control information to the peripheral device. Another type of peripheral device contains its own output rendering engine that is capable of generating an output document from raw output job data. Although this type of peripheral device contains its own output rendering engine, it is typically coupled to a document processing device, such as a computer, to receive the raw output job data generated, for example, by an application running on the computer.

The document processing device, typically in home and office environments, consistently communicates to one or more of the same peripheral devices each time that an output job is to be output thereon. In other situations, such as in mobile computing, the document processing device must direct output to a peripheral device upon which output has not been previously directed by the document processing device. To do so, the document processing device must have specific software corresponding to the specific peripheral device upon which the output job is to be output. By way of example, a specific printer driver must be installed on a personal computer (PC) that corresponds to a specific printer so that a document can be printed on the printer by executing a printing function of a document processing application executing on the PC. In that there are a great variety of printers and corresponding printer drivers that can be encountered in mobile computing, it is not likely that a personal computer would have all printer drivers installed thereon so as to readily direct print jobs to all corresponding printers. In practice, a time consuming process is required in which a PC user must determine the type of printer that is to be printed to. Then, the PC user must locate and install a compatible printer driver on the PC that corresponds to the printer that the PC user wants to print on. This process must be repeated for each different kind of printer that the PC user needs to use.

A port monitor can be used to direct output to a peripheral device. When a PC user makes a “function-print”demand from a document processing application, the PC user specifies the particular peripheral device to which output is to be directed by the printer driver. The printer driver can be connected through a port monitor to a print queue for each respective printer that can be requested by the PC user. The port monitor can be physically connected to a peripheral device or by a physical connection to a network address so that the output can be directed. Where the peripheral device is a printer, the port monitor requires a connection to the printer so that a print job can be sent directly through the port monitor to the printer. Rather than directing output to the printer, the port monitor can print to a file. When the port monitor prints to a file, the PC user must specify both its name and its address so that the file can save therein a print job for later printing.

Output from a printer driver may need to be processed prior to being output by a peripheral device. This processing is not performed by a port monitor that receives the output from the printer driver. Rather, the processing function may need to be performed by the peripheral device itself, thus increasing both the complexity and cost of the peripheral device. It would be advantageous to advance compatibility and ease of use between a document processing device and a peripheral device upon which an output job is to be output by providing an ability to re-direct output from a printer driver to a configurable location where the output could be processed prior to being routed to a peripheral device to be output therefrom. Consequently, there is a need for improved methods, programs, client devices, and systems that can provide such a capability.

### SUMMARY OF THE INVENTION

The above-stated needs and/or others are met, for example, by methods, programs, client devices, and systems in which one or more configuration files are accessed to obtain therefrom a naming convention from which can be derived a file name for a file that is to contain information that is to be output with a peripheral device. Also obtained from the one or more configuration files is an address of a directory for storing the file having the file name that is to contain information that is to be output with the peripheral device, and an address to which information is to be transmitted that is to be output at the peripheral device. The file having the file name in accordance with the naming convention is created in the directory and print data created by execution of an output application is input into the file having the file name in the directory. The print data in the file in the directory is sent to the address for transmitting data that is to be output at the peripheral device.

### DESCRIPTION OF THE DRAWINGS

In the drawings, the same reference numbers are used throughout the drawings to reference like components and features.

FIG. 1 illustrates a network environment in which multiple servers, workstations, and peripheral devices including printers are coupled to one another via an interconnected network.

FIG. 2 is a block diagram showing pertinent components of a computer workstation for outputting to a peripheral device in accordance with an embodiment of the present invention.

FIG. 3 is a block diagram showing pertinent components of a peripheral device in accordance with an embodiment of the present invention.

FIG. 4 is a flow diagram illustrating a procedure for processing a particular output job.

### DETAILED DESCRIPTION

The methods, programs, client devices, and systems, according to various embodiments of the present invention, relate to a client device or document processing device such as personal computer (PC) that executes a document processing application, such as a word processor application, that creates and/or stores a document that is to be output at a peripheral device, such as a printer. Where the PC has not previously directed a document for printing at the printer, the PC must first be set up. One such an environment that calls for the PC to be set up is in mobile computing. A typical mobile computing environment is that of a traveler who uses a laptop computer or other mobile computing device. The laptop computer has a document processing application installed thereon. The document processing application typically has a printer driver application that can be used to create a print data from a document that the traveler has stored and/or created. In order to print out the document, the traveler locates an available printer upon which to print the document. Public accommodations and meeting facilities, such as those often associated with the hospitality industry, often offer printers to guests for their use.

In order to print a document on the available printer that the traveler has located, data and software are installed on the laptop computer. The data can include a configuration file and the software can include a redirecting application and a printing solution application. These data and software can be obtained by copying same from portable media or by download from an interconnected network that is also in communication with the printer that the traveler has located. The traveler then operates the document processing application to request the printing function thereof so as to obtain the desired print out on the located printer that the traveler specifies in requesting the printing function.

After the traveler has made this request, the document processing application executes the printer driver application to create print data from the document being processed by the document processing application. The redirecting application, which can be executed in background, accesses the configuration file to obtain information about the printer that the traveler has requested. The access to the configuration file provides the address of a directory in a file system in which print data files for the requested printer are to be stored. A file naming convention is also supplied by the access to the configuration file. The redirecting application creates a print data file in the directory specified by the configuration file for the requested printer. The print data file is named according to the naming convention specified for the requested printer in the configuration file. Print data from the printer driver is then written to the print data file by the redirecting application.

The printing solution application accesses the configuration file to obtain the address of the directory in the file system in which print data files are stored for the requested printer. Once obtained, the address of the directory is monitored in background by execution of the printing solution application so as to detect the presence of any new print data files stored thereat that are to be printed at the requested printer. When the monitoring function of the printing solution application detects the presence of any print data file stored in the directory at the monitored address, the configuration file is accessed by the printing solution application to obtain an address of the requested printer as well as to obtain the address of an output port to which print data in the detected new print data file is routed. The print data in the print data file in the monitored directory is then routed to the address of the output port by the printing solution application and from the output port to the address of the requested printer for printing. The printer receives the print data from the address of the output port as was obtained from the configuration file. Upon receipt, the requested printer may additionally process the print data or may directly print out the print data in a hardcopy report. The traveler can then retrieve the print out, having accomplished the desired result.

In one embodiment of the present invention, a server in communication with the interconnected network includes a storage area that stores both the configuration file as well as installation software for installing the redirecting application and the printing solution application. The traveler can connect the laptop computer to the server through the interconnected network to request and receive from the storage area both the configuration file and the installation software. Upon receipt, the laptop computer then operates upon the installation software to install both the redirecting application and the printing solution application.

In one embodiment of the present invention, the printer that the traveler has located and requested has an Internet address and the print data in the specially named print data file stored in the directory designed for the requested printer is transmitted over the Internet to the Internet address to be printed at the requested printer. In another embodiment of the present invention, the address of the requested printer is a network address on a local area network and the print data to be printed is routed over the local area network to the network address to be printed at the requested printer.

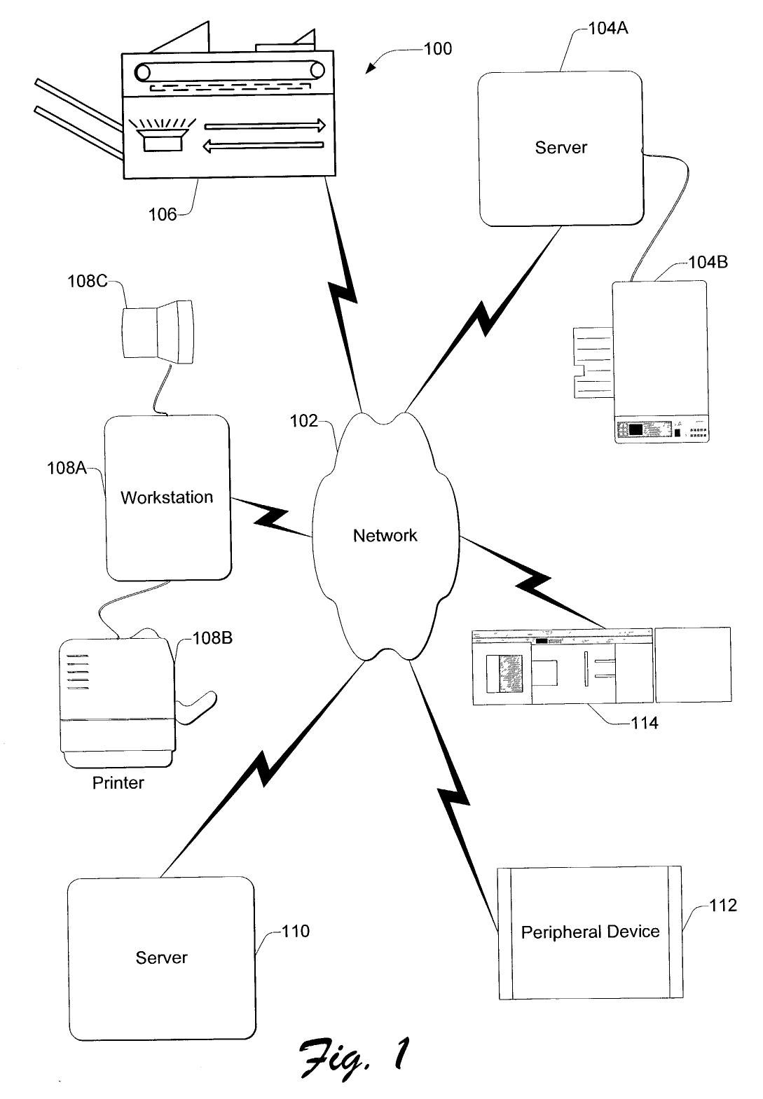

FIG. 1 illustrates a network environment 100 in which a plurality of network resources are communication via an interconnected network 102. As such, multiple servers 104A, 110, workstations 108A, and peripheral devices 104B, 106, 108C, 108B, 112, 114 are coupled to one another via interconnected network 102. Interconnected network 102 couples together servers 104A and 110, computer workstations 108A, printers 104B, 106, 108B, 112, and 114, and a computer monitor 108C. Printers 104B, 108B and computer monitor 108C are coupled to interconnected network 102 through their respective local connections to server 104A and workstation 108A. Interconnected network 102 can be any type of network, such as a local area network (LAN) or a wide area network (WAN), using any type of network topology and any network communication protocol. In a particular embodiment, interconnected network 102 can be the Internet. Although only a few devices are shown coupled to interconnected network 102, a typical network may include tens or hundreds of devices coupled to one another. Furthermore, interconnected network 102 may be coupled to one or more other networks, thereby providing coupling between numerous devices.

Servers 104A and 110 may be file servers, e-mail servers, database servers, print servers, or any other type of network server. Workstation 108A can be any type of computing device, such as a mobile computing device, including a personal computer, a laptop computer, and a personal digital assistant (PDA). Although not shown in FIG. 1, one or more workstations and/or servers may contain a print rendering engine capable of converting raw print job data into a particular format (e.g., language) understood by certain types of printers.

Particular embodiments of the invention illustrate an ink jet printer 104B and laser printers 106, 108B. Alternate embodiments of the invention, however, are implemented with other output devices such as with peripheral device 112 that is illustrated as being in communication with interconnected network 102 independent of a server or workstation. Peripheral device 112 is intended to represent an output device to which output can be directed from a computing device, including but not limited to, laser printers, ink-jet printers, bubble-jet printers, copiers, and fax machines. Additionally, peripheral device 112 can be any type of device that can output an output job, including by soft copy such as by video display or by hardcopy such as on paper, and any other type of printer including those referred to above. A digital press or network copier 114 is seen in FIG. 1 as a peripheral device to which output can be direct according to an embodiment of the present invention.

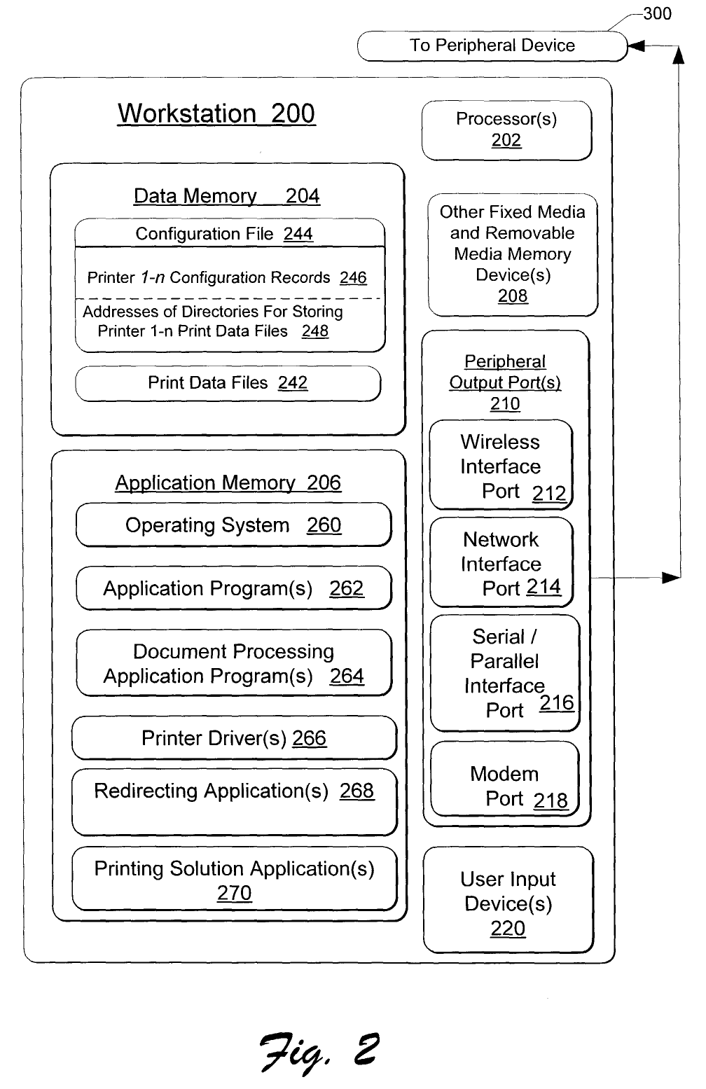

FIG. 2 is a block diagram showing pertinent components of a computer workstation 200 in accordance with the present invention. Workstation 200, which is a computing device, includes one or more processors 202, a data memory 204, an application memory 206, and other fixed media and removable media memory devices 208. Memory devices 204, 206, and 208, which provide data storage mechanisms, can be read-only memory (ROM), random access memory (RAM), a hard drive, a floppy disk drive, a CD-ROM drive, and other conventional memory device, and can be used to store an output buffer that contains a rendered version of a document, a bitmap of an image of one or more pages or segments of a document, or other versions of the document as is appropriate for a particular outputting environment. Other storage uses include a print spool or print buffer.

The one or more processors 202 perform various instructions to control the operation of workstation 200. The instructions can be in applications that can be stored in memory devices 204, 206, and 208. These applications include an operating system 260, one or more application programs 262, and one or more document processing applications 264 to process a document such as word processing programs, electronic mail programs, drawing programs, spreadsheet programs, slide show programs, and desk top publishing programs, where some applications can include a spooler component. Also included in the applications executed by the one or more processors 202 are one or more printer drivers 266, one or more redirecting applications 268, and one or more printing solution applications 270. When executed by the one or more processors 202, each printer driver 266 outputs data to one or more of the redirecting applications 268 for further processing.

Data memory 204 includes various types and kinds of data. A configuration file 244 includes a plurality of configuration records, respectively, for printers 1-n. Configuration file 244 also stores an address for each directory in a file system that is designated to store print data files 242 for each printer 1-n. Print data in the print data file 242, which are formed by output from the one or more redirecting applications 268, can be specifically formatted according to each printer 1-n to which the data is to be directed.

Although FIG. 2 shows data memory 204 with the configuration file 244 and shows the application memory 206 with the one or more redirecting applications 268, these components could also be stored on a server, such as one or more servers 104A and 110 seen in FIG. 1 and to which workstation 200 would have access through interconnected network 102.

The contents of configuration file 244 can be maintained by operation from workstation 200 for efficient architecture of the network environment 100 seen in FIG. 1. This maintenance can include the specification of those directories in a file system that are to be used by the one or more printing solution applications that monitor and detect the presence of new print data files in the specified directories. The formatting requirements of each such file can also be maintained so that all or a portion of the file in the file system can be printed at a particular printer that is designated by a user. This maintenance can be performed by a network administrator who also can set up a generic printing solution application that addresses output to a bank of printers having specific capabilities (e.g. color printing, high volume printing). As such, the user wanting to print a print job need only specify the capabilities of a printer rather than identifying a specific printer or IP address of a printer. The network administrator can remotely change a configuration file for specific peripheral devices to enable and disable output thereto, such as when a printer is malfunctioning and printing must be directed to a different printer having similar capabilities. Different output ports for each of several different printer drivers can be configured by the network administrator such that the configuration file contains information so as to provide a programmable way of changing the output from the one or more redirecting applications, simply by changing the data in the configuration file. By way of example, a single printing solution application may need different information for different output ports or for different printer drivers, each of which could be reflected in the configuration file. For example, the configuration file could provide address data such that a redirecting application could use different directories for different output ports or could use different IP addresses to which print data could be routed through a network port. Thus, one printing solution application can then process output from a variety of sources using a single, configurable redirecting application.

One or more peripheral output ports 210 provide a mechanism for workstation 200 to communicate with other devices such as to a peripheral device 300. The one or more printing solution applications 270, when executed, direct data to one or more peripheral output ports 210, which can be a wireless interface port 212, a network interface port 214, a serial port/parallel port 216, and/or a modem port 218. User input device(s) 220 can be used for inputting and outputting data. User input device(s) 220 include a keyboard, mouse, pointing device, or other mechanism for inputting information to workstation 200.

Workstation 200 can include one or more rendering engines in application programs 262 each of which can be executed by the one or more processors 202 that are capable of processing print data into a format understood by respective peripheral devices so as to be output therefrom. Similarly, the servers 104A, 110 and the workstation 108A seen in FIG. 1 can include respective rendering engines that can process raw data into a language understood by any printer or peripheral device connected on network 102. These rendering engines can be capable of rendering a document into a directly printable format by incorporating any fonts, templates, or other data required to render the document.

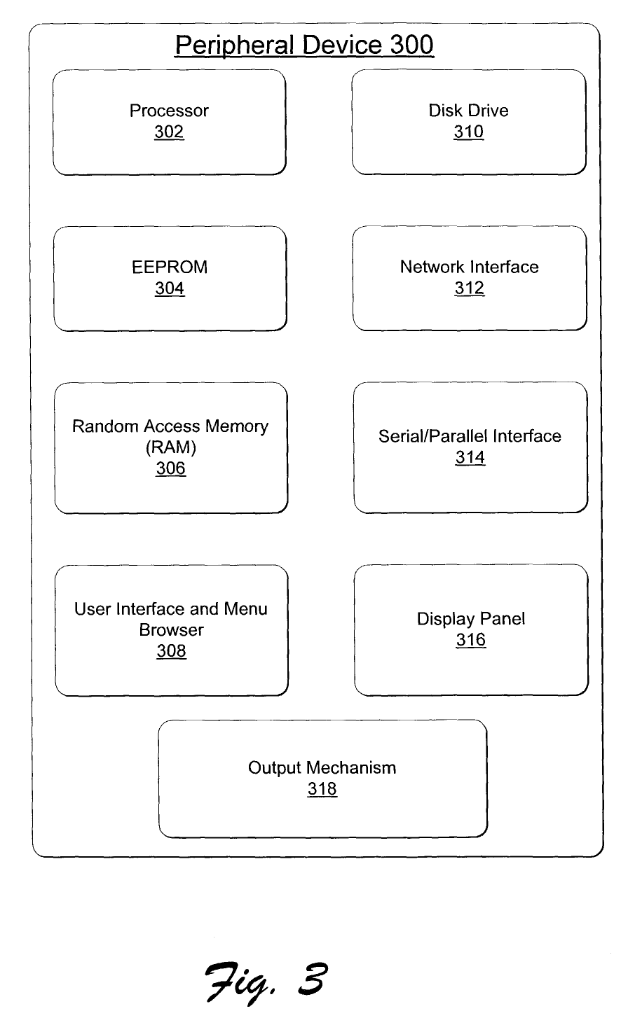

FIG. 3 is a block diagram showing pertinent components of a peripheral device 300 which can be used to output an output job. For example, peripheral device 300 can be a printer that includes one or more processors 302, hardware components of a printing device in an output mechanism 318, an electrically erasable programmable read-only memory (EEPROM) 304, and a random access memory (RAM) 306. The one or more processors 302 process various instructions necessary to operate peripheral device 300 and communicate with other devices. EEPROM 304 and RAM 306 can be used to store various types of information such as configuration information, fonts, templates, data being printed, and menu structure information. Although not shown in FIG. 3, a particular peripheral device may also contain a ROM (non-erasable) in place of or in addition to EEPROM 304.

Peripheral device 300 can optionally include a disk drive 310, a network interface 312, and a serial/parallel interface 314. Disk drive 310 provides additional storage for data being printed or other information used by peripheral device 300. Although both RAM 306 and disk drive 310 are illustrated in FIG. 3, a particular peripheral device may contain either RAM 306 or disk drive 310, depending on the storage needs of the peripheral device. For example, an inexpensive printer may contain a small amount of RAM 306, no disk drive 310, and a modest print engine, thereby reducing the manufacturing cost of the printer. As such, to print most documents, peripheral device 300 will require assistance from a rendering engine can that be found in a server or workstation with which peripheral device 300 is in communication.

The storage needs of the peripheral device may require the storage of a printer engine in any of the storage components described above. In one embodiment of the invention, peripheral device 300 stores an output buffer containing a pre-rendered document in one or more of RAM 306 and disk drive 310. In another embodiment of the invention, peripheral device 300 has a memory for storing a pre-rendered document received from an output buffer, where peripheral device 300 formats the pre-rendered document so that it can be output by output mechanism 318.

Network interface 312 provides a connection between peripheral device 300 and a data communication network, such as interconnected network 102 seen in FIG. 1. Network interface 312 allows devices coupled to a common data communication network to send print jobs and other information to peripheral device 300 via the network. Similarly, serial/parallel interface 314 provides a data communication path directly between peripheral device 300 and another device, such as a workstation, server, or other computing device. In one embodiment of the present invention, workstation 200 seen in FIG. 2 can direct data for printing from one or more peripheral output ports 210 through interconnected network 102 seen in FIG. 1 to network interface 312 of peripheral device 300 to be printed out. In another embodiment of the present invention, workstation 200 directs data for printing from one or more peripheral output ports 210 through a cable directly connected to serial/parallel interface 314 of peripheral device 300 to be printed out. Although the peripheral device 300 shown in FIG. 3 has two interfaces (network interface 312 and serial/parallel interface 314), a peripheral device may only contain one interface. Additionally, the interface can be other types of interfaces known in the art, such as Universal Serial Bus (USB), IEEE 1394, etc.

Peripheral device 300 can also contains a user interface/menu browser 308 and a display panel 316. User interface/menu browser 308 allows the user of peripheral device 300 to navigate a menu structure that is displayed by peripheral device 300 on display panel 316. User interface 308 may be a series of buttons, switches or other indicators that are manipulated by the user of peripheral device 300. Display panel 316 can be a graphical display that provides information regarding the status of peripheral device 300 and the current options available through the menu structure. In a particular embodiment of the invention, the display panel 316 is a liquid crystal display having a two-dimensional array of pixels capable of generating various fonts, icons, and other images. In one implementation of the invention, user interface 308 is a touch-sensitive screen that overlays display panel 316. Thus, the user can provide input to peripheral device 300 by touching the appropriate portion of the touch screen. The touch screen is substantially transparent such that the images displayed on panel 316 are visible to the user through the touch screen. The touch screen may be used in combination with one or more physical buttons or switches on peripheral device 300.

The display panel 316 of peripheral device 300 displays various menu options to the user of peripheral device 300. The display panel 316 and associated control buttons allow the user of peripheral device 300 to navigate, for instance, a menu structure that has a hierarchy of menu elements. When one of the menu elements is selected, the display changes to illustrate the new menu elements in the next level of the hierarchy. Alternatively, if the selected menu element is a function or other action to be performed by peripheral device 300, the appropriate procedure is performed. For example, if the selected menu element outputs a particular document, then peripheral device 300, serving in the role of a peripheral device, performs the necessary operations to output the output job, such as by outputting a formatted version of a rendered document that is received by transfer from an output buffer or through network interface 312 from a data communication network.

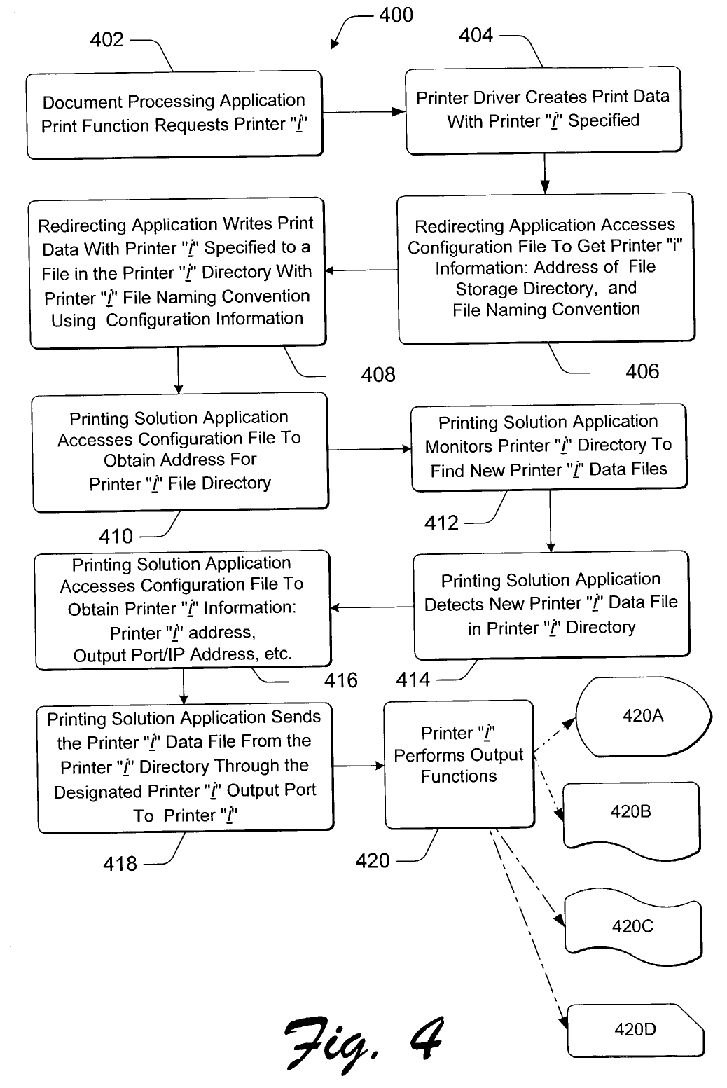

FIG. 4 is a flow diagram illustrating an embodiment of the present invention as depicted in a procedure 400 for processing a particular output job. Procedure 400 begins at block 402 where a document processing device executes a document processing application on one or more processors. A user can open a document using an operation of the document processing application. When the user wishes to output the document, the user inputs a request to the document processing application so as to initiate a print function. The input from the user specifies a particular peripheral device or printer “i” upon which the document is to be output or printed. The document processing application can be a word processing application (e.g. Word® software from Microsoft Corporation), a financial application (e.g. Money® software from Microsoft Corporation), a network browser (e.g. Internet Explorer® software from Microsoft Corporation), a network messaging application, a spreadsheet application (e.g. Excel® software from Microsoft Corporation), a data base maintenance application (e.g. Access® software from Microsoft Corporation), or slide show application (e.g. Power Point® software from Microsoft Corporation), where the user of the document processing application specifies a particular peripheral device (e.g. printer) at which to output a document.

At block 404, a printer driver creates print data that is specified to be printed with the printer “i”. The printer driver submits the printer “i” print data to a redirection application at block 406. The redirection application is executed on the one or more processors to access a configuration file to obtain an address of a directory in a file system that is designated to store data that is to be printed by the printer “i”. Other configuration information with respect to the printer “i” can also be obtained during this access to the configuration file, such as a naming convention for the files that are to be stored in the directory specified for the printer “i”.

The configuration file can be structurally organized as a file having one or more record types therein, each of which contain fields having data therein that are of or relating to printing functions associated, respectively, with one or more printers. Alternatively, the configuration file can be a registry containing entries each of which relates to printing functions associated, respectively, with one or more printers. The availability of printers for printing can be included in the configuration file, as well as a respective network address or local address for each printer. The respective address of the directory in the file system that is to be used to store print data files for each respective printer is defined in the configuration file. Communication protocol information about the physical port connection for each printer can also be kept in the configuration file, such as network, serial, parallel, USB, IEEE 1394, and other communication protocol information. Characteristics and capabilities of each printer can also be kept in the configuration file, including color printing capabilities, laser or ink-jet capabilities, dot-matrix or laser capabilities, etc. By use of this information in the configuration file, data can be formatted, changed, or otherwise made compatible for printing at each respective printer.

The configuration file can be maintained by a PC user or by a network administrator of a network on which a network resource is found that stores the configuration file. As such, the configuration file can reside on a PC, a server, or on another network resource. The configuration file can be optimally maintained so as to permit the efficient and proper routing of output jobs to as many peripheral devices as is practical for a network of peripheral devices and potential users thereof.

At block 408, the redirecting application creates a file in the directory specified for printer “i” at the address specified in the configuration file, where the file is named according to the naming convention specified in the configuration file for printer “i”. By accessing the configuration file, the redirecting application can be made to be versatile with respect to input from a variety of printer drivers each of which specifies a particular printer. The access that the redirection application makes to the configuration file permits the determination of where to create the print data file using the print data received from the printer driver. Thus, the redirecting application can handle the output from multiple printer drivers so as to form a corresponding printer data file at a proper directory address with a proper naming convention and with any additional information required for outputting an output job at a user-requested peripheral device.

At block 410, a printing solution application is executed on the one or more processors. The printing solution application accesses the configuration file to obtain an address for the directory that is designated to store print data files for which the respective print data therein is to be printed by the printer “i”. At block 412, the printing solution application performs a monitoring function at the directory address to detect any new print data file that has been written to the directory. When any such new print data file is detected at the address in the directory during the monitoring function at block 414, the printing solution application at block 416 accesses the configuration file to obtain various printer “i” information. The printing solution application obtains the address of printer “i” as well as an output port and/or an IP address to which data is to be routed for transmission to printer “i” to be printed. The physical port connection data that is to be used for printer “i” can be a network port, a serial port, a parallel port, a USB port, a IEEE1394 protocol port, etc. It is thus intended that each printer can receive a transmission of data thereto that is specific thereto as directed by respectively specific record(s) of the configuration file. The print data so transmitted is stored in the print data file that has an address at the directory that is designated specifically for printer “i” according to a corresponding record or entry in the configuration file. At block 418, the printing solution application sends the print data in the printer data file at the address of the directory designated for printer “i” to printer “i” via the output port and/or IP address specified in the configuration file.

In summary, the printing solution application is configured by access to data in the configuration file, having received input from a print data file in a directory of a file system that is specified for use of a user-designated printer. The printing solution application directs outputs to the user-designated printer by interfacing with the configuration file to obtain necessary information. This access to the configuration file is made to determine where to find a printer data file that was created by the redirecting application. The print data in the printer data file, which is to be printed at the user-designated printer, can contain indicators as to the type of print data, the port to which output is to be directed, the printer driver originating the corresponding data, the size of the data in the print data file, and various characteristics of the data (e.g. size, volume, and color printing aspects and considerations). The printing solution application, based upon the print data in the printer data file and the contents of the configuration file that are specific to the user-designated peripheral device, can determine an appropriate peripheral device to output a requested report, any reformatting or modifications that are to be made to the print data in the print data file prior to outputting the report, and any transmission protocol information to be added to the print data file to transmit the print data therein in a network-specific communication protocol. Moreover, the printing solution application can add specific data from each printer driver to the print data in the print data file before the print data is sent to a user-designated peripheral device. The foregoing flexibility allows the printing solution application to support print data created by multiple printer drivers for directing the same to multiple printers. As such, the printing solution application can processes different print data files in their respectively designated printer “i” directories, each having been created by the redirecting application. The versatility of interoperability with any of a variety of printer drivers is accomplished by the configurability of both the redirecting application and the printing solution application through their respective access to the configuration file.

The print data that is transmitted to printer “i” can be print data that is specifically altered or formatted. Such an alteration or formatting can be made so that the print data will be specifically compatible to the requirements of printer “i”. The compatibility requirements can be based upon information that can be stored in and obtained from the configuration file by access thereto by one or more of the redirecting application or the printing solution application.

At block 420, the print data that has been transmitted to printer “i” is printed in a report. Alternatively, printer “i” can be varied kinds of peripheral devices that can output a report. The output at printer “i” may require some specific formatting or pre-processing to be performed by printer “i” prior to the report being produced. The report requested can be made with a hardcopy printed report 420B, a continuous printout such as a ticker tape 420C, or other hardcopy such as a punch card 420D. Alternatively, the output can be directed to a video projection or display device 420A so as to output a soft copy of the requested document. Following the outputting of the output job from the output buffer by the peripheral device, the file in the directory of the file system designated for printer “i” that contained the print data in the report can optionally be removed from the directory, such as by logically and/or physically purging the file. Procedure 400 can be repeated for each document processed by the document processing device in which a peripheral device receives input from the printing solution application and outputs a report or hardcopy.

The order in which the method is described with respect to procedure 400 is not intended to be construed as a limitation, and any number of the described method blocks can be combined in any order to implement the method. Furthermore, the method can be implemented in any suitable hardware, software, firmware, or combination thereof.

When procedure 400 is operated in an environment where the document processing device is a PC and the peripheral device is a printer, several parameters of operation can be implemented within the context of the rendering of the document in the PC and the rendering of the document in the printer. To process an entire print job, the printer may need the ability to interpret a language or format in which the document is stored. For example, if the document data is stored in a raw data format and the printer only understands the Printer Control Language (PCL) language, then the printer cannot process the document until some other device or process converts the raw data into a PCL format. Here, the PC can be this device or perform this process. However, if the document is already stored in a format that is understood by the printer, then the printer can process the document without assistance from an external device. If the printer can process the entire print job, then the document is printed by the printer. If the printer cannot process the entire print job, then the portions of the document (i.e., print job) that it cannot process are delegated to other processing devices.

In a particular embodiment of the present invention, the printer can only render documents that are formatted in the native language of the printer. Thus, the printer may require all portions of a particular print job to be processed by the PC if all portions of the print job are in a non-native language of the printer. By supporting only a native printing language, the cost of such a printer is reduced.

The output document can have many forms. For instance, the document can be a letter containing text that is being edited by a word processing program, an electronic mail (e-mail) message that is being created by an e-mail program, a drawing that is created by the user by operating a drawing program, a spreadsheet that the user is constructing by operating a spreadsheet program, or a poster that is being designed by a user by operating a desk top publishing program. Other types of documents are also contemplated for use in embodiments of the present invention.

In one embodiment of the present invention, the peripheral device can be a printer, such as a simple dot matrix printer or a complex printer such as a digital press or a network printer. Complex printers can have capabilities that include high quality photo reproduction, multi-section reports with tabs, in-line mixed material insertion such as insertion of full-color preprinted copies and digital color-page insertion. Other complex printer capabilities include printing on substrates of varied composition, such as embossed, heavy-weight, multi-weight, and cover paper stock, as well as carbonless paper, blue prints, clear or colored transparency printing, and other specialty stock including preprinted offset color covers. Still other complex printer capabilities includes binding, collating, folding, stacking, stapling, stitching such as saddle stitching, edge-trimming, paginating for multi-language, and inline pagination and annotation. Still another printer is a multifunction peripheral (MFP), sometimes referred to as an “All-In-One”, which combines two or more peripheral devices into a single device, such as printing, scanning, copying, and facsimile transmission. The printer can be a Graphical Display Interface (GDI) printer or a printer interpreting a page description language.

In another embodiment of the present invention, the document processing application executes on the processor of the document processing device to form a bitmap image of a document that is communicated to the peripheral device through the interconnected network. In still another embodiment of the present invention, the document processing application is included in a word processing application. In yet another embodiment of the present invention, the document processing application includes a spooler for spooling print jobs that are to be communicated to the peripheral device through the interconnected network or through a hardware port on a PC.

Thus, although some preferred embodiments of the various methods, programs, client devices, and systems of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the scope of the invention as set forth and defined by the following claims.

What is claimed is:

1. A computer-readable medium having computer-executable instructions which, when executed on a processor, direct a computer to perform a method comprising:
accessing one or more configuration files to obtain therefrom:
a convention for deriving a file name for a print file that is to contain information that is to be output with a printer;
a first address of a directory for storing the print file; and
a second address to which information is to be transmitted that is to be output at the printer;
creating the print file having the derived file name in the directory at the first address;
inputting print data into the print file; and
sending the print data to the second address.

2. The computer-readable medium as defined in claim 1, wherein:
the second address is an Internet address; and
the sending the print data to the second address comprises transmitting the print data in the print file over the Internet to the Internet address to be output by the printer.

3. The computer-readable medium as defined in claim 1, wherein:
the second address is a network address on a local area network; and
the sending the print data to the second address further comprises transmitting the print data in the print file over the local area network to the network address to be output by the printer.

4. The computer-readable medium as defined in claim 1, wherein the method further comprises:
associating an output-pending status with the print file; and
monitoring to detect the presence of any file in the directory having the output-pending status associated therewith; and
for each said file in the directory associated with the output-pending status as detected by said monitoring, performing:
said creating;
said inputting; and
said sending.

5. The computer-readable medium as defined in claim 1, wherein:
the accessing one or more configuration files occurs after notice of a pending request to print at the printer from a printer driver application invoked by a document processing application processing a document that contains the print data to be printed at the printer; and
the inputting the print data into the print file further comprises transforming the print data into a format that is required for printing by the printer.

6. A computer-readable medium having computer-executable instructions which, when executed on a processor, direct a computer to perform a method comprising:
deriving a print file name for a print file to contain data to be output with a peripheral device;
obtaining a first address of a print directory for storing the print file with the print file name;
obtaining a second address for transmitting data to be output at the peripheral device;
creating the print file at the first address so as to contain the data to be output with the peripheral device;
associating an output-pending status with the print file;
monitoring to detect the presence of any file at the first address having the output-pending status associated therewith;
for each said file at the first address associated with the output-pending status as detected by said monitoring:
sending the data therein to the second address; and
removing the output-pending status.

7. The computer-readable medium as defined in claim 6, wherein the method further comprises:
accessing a configuration file that includes:
information about transforming data so as to be compatible for output at the peripheral device;
a naming convention from which can be derived the print file name for the print file to contain data to be output with the peripheral device;
the first address; and
a third address for a port through which to transmit data to be output at the peripheral device.

8. The computer-readable medium as defined in claim 6, wherein the method further comprises, prior to the creating the print file:
creating the data to be output with the peripheral device with a printer driver application.

9. The computer-readable medium as defined in claim 8, wherein the printer driver application formats a printer control language to control the peripheral device.

10. The computer-readable medium as defined in claim 8, wherein the creating the data to be output with the peripheral device with a printer driver application further comprises:
invoking the printer driver application with a document processing application for processing a document, wherein the document contains at least part of the data to be output with the peripheral device.

11. The computer-readable medium as defined in claim 10, wherein the document processing application includes a spooler for spooling print jobs.

12. The computer-readable medium as defined in claim 10, wherein the document processing application selected from the group consisting of a word processing application, a spreadsheet application, a financial application, a network browser, a network messaging application, a spreadsheet application, a data base maintenance application, and slide show application.

13. The computer-readable medium as defined in claim 6, wherein for each said file at the first address having the output-pending status detected by said monitoring:
transforming any data therein as required to be compatible with the peripheral device.

14. The computer-readable medium as defined in claim 6, wherein the obtaining the first address and the obtaining the second address both further comprise:
accessing a configuration file containing information about transforming data so as to be compatible for output at the peripheral device.

15. The computer-readable medium as defined in claim 14, wherein the information includes:
a naming convention from which can be derived the print file name for the print file to contain data to be output with the peripheral device;
the first address; and
a third address for a port through which to transmit data to be output at the peripheral device.

16. The computer-readable medium as defined in claim 6, wherein:
the deriving a print file name for a print file to contain data to be output with a peripheral device comprises accessing a configuration file having data therein that contains a naming convention for deriving the print file name of the print file.

17. The computer-readable medium as defined in claim 6, wherein the obtaining the first address comprises accessing a configuration file having data that therein that contains the address for storing the print file.

18. The computer-readable medium as defined in claim 6, wherein:
the obtaining the second address comprises accessing a configuration file having data that therein that contains an address of a port through which to transmit the data to be output at the peripheral device.

19. The computer-readable medium as defined in claim 6, wherein:
the monitoring to detect the presence of any file at the first address having the output-pending status associated therewith comprises detecting in the print directory whether any new files have been written to the directory.

20. The computer-readable medium as defined in claim 6, wherein, for each said file in the directory associated with the output-pending status as detected by said monitoring, the removing the output-pending status further comprises logically deleting the file associated with the output-pending status.

21. The computer-readable medium as defined in claim 6, wherein:
the second address is an Internet address; and
the sending the data therein to the second address further comprises transmitting the data therein over the Internet to the Internet address to be output by the peripheral device.

22. The computer-readable medium as defined in claim 6, wherein:
the second address is a network address on a local area network; and
the sending the data therein to the second address further comprises transmitting the data therein over the local area network to the network address to be output by the peripheral device.

23. The computer-readable medium as defined in claim 6, wherein the peripheral device is selected from the group consisting of a digital press, a Graphical Display Interface (GDI) printer and a printer interpreting a page description language.

24. A computer-readable medium having computer-executable instructions which, when executed on a processor, direct a computer to perform a method comprising:
accessing configuration information that includes:
a naming convention from which can be derived a file name for each file that is to contain information that is to be output with the peripheral device; and
an address:
of a directory for storing each said file having a respective said file name that is to contain information that is to be output with the peripheral device; and
to which information is to be transmitted that is to be output at the peripheral device;
creating, with a printer driver application, at least one set of print data that is to be output with the peripheral device;
for each said set of print data:
deriving, from the naming convention, one said file name for one said file to contain the respective said print data;
creating the one said file with the one said file name at the address of the directory so as to contain the respective said print data to be output with the peripheral device; and
associating an output-pending status with the one said file with the one said file name;
monitoring to detect the presence of any file in the directory having the output-pending status associated therewith; and
for each said file in the directory associated with the output-pending status as detected by said monitoring:
sending the respective said print data therein to the address for transmitting data to be output at the peripheral device; and
removing the respective said output-pending status.

25. The computer-readable medium as defined in claim 24, wherein the creating the one said file with the one said file name at the address of the directory so as to contain the respective said print data to be output with the peripheral device further comprises:
transforming the respective said print data therein as required to be compatible with the peripheral device.

26. The computer-readable medium as defined in claim 24, wherein the printer driver application formats a printer control language to control the peripheral device.

27. The computer-readable medium as defined in claim 24, wherein the creating, with a printer driver application, at least one set of print data that is to be output with the peripheral device further comprises:
invoking the printer driver application with a document processing application for processing a document, wherein the document contains at least part of the data to be output with the peripheral device.

28. The computer-readable medium as defined in claim 27, wherein the document processing application includes a spooler for spooling print jobs.

29. The computer-readable medium as defined in claim 28, wherein the document processing application selected from the group consisting of a word processing application, a spreadsheet application, a financial application, a network browser, a network messaging application, a spreadsheet application, a data base maintenance application, and slide show application.

30. A client device comprising a processor in communication with a memory, wherein:
the memory includes a printer driver application, a redirecting application, a printing solution application, a file storage area, and a configuration file;
the processor executes the printer driver application to give notice that print data is to be printed at an identified printer;
the processor executes the redirecting application to:
access the configuration file to obtain therefrom:
a naming convention from which can be derived a file name for a file that is to contain information that is to be output with the identified printer; and
an address:
of a directory in the file storage area for storing the file having the file name that is to contain information that is to be output with the identified printer; and
to which information is to be transmitted that is to be output at the identified printer;
create in the directory the file having the file name in accordance with the naming convention;
receive print data created by execution of the printer driver application by the processor; and
input the print data to the file having the file name in the directory; and
the processor executes the printing solution application to send the print data in the file in the directory to the address for transmitting data to be output at the identified printer.

31. The client device as defined in claim 30, wherein the processor executes the printing solution application further to:
monitor the address of the directory to detect the presence of data stored thereat that is to be printed at the identified printer; and
after said detection of the presence of data stored at the address that is to be printed at the identified printer:
send the data stored at the address that is to be printed at the identified printer to the address for transmitting data to be output at the identified printer.

32. The client device as defined in claim 30, wherein:
the address for transmitting data to be output at the identified printer is an Internet address; and
the send the print data in the file in the directory to the address for transmitting data to be output at the identified printer further comprises transmitting the print data over the Internet to the Internet address to be printed at the identified printer.

33. The client device as defined in claim 30, wherein:
the address for transmitting data to be output at the identified printer is a network address on a local area network; and
the send the print data in the file in the directory to the address for transmitting data to be output at the identified printer further comprises transmitting the print data over the local area network to the network address to be printed at the identified printer.

34. A networked system comprising:
a client device including a processor coupled to a memory, the memory including a file storage area and one or more configuration files, the memory having installed thereon a printer driver application, a redirecting application, and a printing solution application, wherein:
the processor executes the printer driver application to create print data to be printed at a selected printer;
the processor executes the redirecting application to:
access the one or more configuration files to obtain therefrom:
a naming convention from which can be derived a file name for a print file that is to contain information to be output with the selected printer;
a first address of a directory in the file storage area for storing the print file; and
a second address to which information is to be transmitted that is to be output at the selected printer;
create the print file having the derived file name in the directory at the first address;
receive the print data from the execution of the printer driver application;
input the print data to the print file; and
associate an output-pending status with the print file; and
the processor executes the printing solution application to:
detect the presence of any file in the directory having the output-pending status associated therewith; and
for each said file in the directory associated with the output-pending status:
send any print data therein to the second address; and
remove the output-pending status thereof.

35. The networked system as defined in claim 34, further comprising a server including a storage area containing a copy of the one or more configuration files and installation software for the redirecting application and the printing solution application; and
wherein the memory of the client device further includes a software installation application that, when executed by the processor:
requests and receives from the server a copy of the one or more configuration files and the installation software; and
installs in the memory, using the installation software, the redirecting application and the printing solution application.

36. The networked system as defined in claim 34, wherein the second address is an Internet address.

37. The networked system as defined in claim 34, wherein the second address is a network address on a local area network.

38. The networked system as defined in claim 34, wherein:
the selected printer receives the information that is to be output at the selected printer; and
the selected printer prints a report containing the information.

39. The networked system as defined in claim 38, wherein the information is received by a printer engine executing on a processor in the selected printer.

40. A client device comprising:
means for creating print data to be output by a peripheral device;
means for executing applications;
means for storing the applications;
means for storing data;
means, stored in the means for storing the applications and when executed by the means for executing applications, for:
storing the print data in a file; and
accessing data in the means for storing data and for deriving therefrom:
an address for the file in the means for storing data; and
a name for the file;
means, stored in the means for storing the applications and when executed by the means for executing applications, for:
accessing data in the means for storing data and for deriving therefrom:
the address for the file in the means for storing data; and
an address of the peripheral device;
means, stored in the means for storing the applications and when executed by the means for executing applications, for:
sending the print data in the file to the address of the peripheral device to be output by the peripheral device.

41. The client device as defined in claim 40, wherein:
the print data is created by a printer driver application when executed by the means for executing applications;
the peripheral device is a printer; and
the address of the peripheral device is an address of an output port of the client device.

42. The client device as defined in claim 41, further comprising:
means, stored in the means for storing the applications and when executed by the means for executing applications, for:
accessing formatting data in the means for storing data and for deriving therefrom information about transforming the print data so as to be compatible with printing by the printer; and
transforming the print data, using said formatting data, so as to be compatible with printing by the printer.

43. A client device comprising:
processor means for executing a plurality of applications;
memory means for storing configuration data and the plurality of applications;
redirecting means, in the memory means and when executed by the processor means, for:
creating print data to be output by a printer;
storing the print data in a print data file;
accessing the configuration data in the memory means;
deriving from the configuration data:
an address for a directory for the print data file in the means for storing data; and
a name for the print data file;
printing solution means, in the memory means and when executed by the processor means, for:
accessing the configuration data in the memory means; and
deriving from the configuration data:
the address for the directory for the print data file; and
an address of the printer;
monitoring the address of the directory for the print data file to detect the presence of the print data file; and
sending the print data in the print data file to the address of the printer to be printed by the printer when the presence of the print data file is detected by the monitoring.
